(19) United States
(12) Patent Application Publication
(10) Pub. No.: US 2023/0118597 A1
(43) Pub. Date: Apr. 20, 2023

(54) DIAMOND MINING CORE DRILL BIT AND METHODS OF MAKING THE SAME

(71) Applicant: Diamond Products, Limited, Elyria, OH (US)

(72) Inventors: Karl H. Moller, North Palm Beach, FL (US); Thomas G. Ruffner, Oberlin, OH (US)

(21) Appl. No.: 17/963,405

(22) Filed: Oct. 11, 2022

Related U.S. Application Data
(60) Provisional application No. 63/255,473, filed on Oct. 14, 2021.

(51) Int. Cl. E21B 10/48; E21B 10/02; B23K 26/28

(52) U.S. Cl. CPC E21B 10/48; E21B 10/02; B23K 26/28

(57) ABSTRACT

A diamond mining core drill bit tool including a cylindrical body with first and second ends and an inner axial opening therethrough, the cylindrical body having a ring groove extending about the second end; the tool further including cutting segments circumferentially spaced about the second end; the tool having a first weld bead between a first portion of the segments and the second end of the cylindrical body; the tool further including at least one weld ring wherein the ring groove is shaped to receive the at least one weld ring such that the at least one weld ring extends about the ring grove; the tool further including at least one second weld bead between a second portion of the segment and the ring groove and a method for the same.

This application claims priority in U.S. Provisional Application Ser. No. 63/255,473 that was filed on Oct. 14, 2021 and that is incorporated by reference into this application.

### FIELD OF THE INVENTION

The present application relates to diamond cutting tools. More particularly, the present application concerns new and improved diamond mining core drill bits and reamers for cutting and reaming rock and earth, and to methods of manufacturing diamond mining core drill bits and reamers.

### INCORPORATION BY REFERENCE

Diamond core drilling equipment is used extensively to drill circular or annular holes in rock, earth, and related materials for a variety of reasons. U.S. Pat. No. 8,210,287 discloses a Mining core drill bit and method of making thereof and is incorporated by reference into this application and forms part of the specification of this application for showing the same. U.S. Pat. No. 9,701,042 discloses a Method of making Mining core drill bit and reamer and is incorporated by reference into this application and forms part of the specification of this application for showing the same. U.S. Pat. No. 9,689,210 discloses a Diamond mining core drill bit and method of making thereof and is incorporated by reference into this application and forms part of the specification of this application for showing the same. U.S. Pat. No. 5,996,571 discloses a Diamond mining core drill bit and is incorporated by reference into this application and forms part of the specification of this application for showing the same.

### BACKGROUND OF THE INVENTION

Diamond core drilling equipment is used extensively to drill circular or annular holes in rock, earth, and related materials for a variety of reasons. For example, holes are drilled in rock during mining or during exploration for purposes of determining soil compaction, determining soil percolation or to perform other geological research.

Prior art diamond core drill bits or hole saws of a general type that are commonly used in mining applications have cutting segments of such bits that are commonly attached using infiltration techniques.

Generally speaking, diamond core drilling equipment comprises a motor-driven core drill assembly including a down-hole mining core drill bit or hole saw. The core drill assembly may embody various configurations, but such assembly generally comprises a base and a guide column extending up from the base or a drilling rig. A carriage may be provided between the column and the motor for guiding the motor along the column as the pipe extensions and mining core drill bit are advanced beneath the ground surface. Generally, the core bit is attached to the pipe extensions using a driver or reaming tool.

The prior art provides various types of core drill bits for use in mining. However, many of the commercial mining bits used today have cutting heads formed of a diamond impregnated (infiltrated) material. More particularly, the cutting head comprises a plurality of cutting segments or teeth mounted at the distal end of the cylindrical body of the bit. Each of the segments can have a uniform concentration of diamond particles dispersed throughout the segments and is attached to the cylindrical body of the bit using an infiltration process. This attachment process, however, is a time consuming operation, it is costly, and may at times result in inadequate adhesion of the segments with the body especially when the segments are highly loaded with diamond particles. Often, the infiltrated material “drips” onto unintended portions of the body and must be cleaned afterwards or fails to adhere properly to the diamond impregnated cutting segments. A substantial investment of energy and time may be required to clean the tool of the stray brazing material and to properly adhere each cutting segment. Additionally, the uniform dispersion of diamonds in the cutting segments may produce only adequate drilling efficiency.

Many of the problems in the prior art were resolved by the inventions disclosed in US U.S. Pat. Nos. 9,689,210 and 9,701,042 wherein a plurality of cutting segments are attached to a drill bit body and wherein the cutting segments and reamer segments are attached by laser welding and capacitive discharge welding to the drill bit body and reamer body, respectively.

### BRIEF SUMMARY OF THE INVENTION

The present invention provides a new and improved diamond mining core drill bit or hole saw for cutting annular holes in rock, earth, and similar materials and, further, includes methods of manufacturing these mining core drill bits. More particularly, the present invention provides a drill bit having cutting segments that are more securely attached to the drill bit body. It has been found that the diamond mining core drill bit according to the present invention is much more durable than even the best prior art mining core drill bits. Even more particularly, the diamond mining core drill bit includes a welded bond between the cutting segments and the drill bit body that is substantially stronger than prior art drill bits.

In one embodiment, a mining drill bit is provided comprising a hollow cylindrical body, a plurality of cutting segments, and at least one weld ring. The hollow cylindrical body has a first end section and an opposite second end section. The plurality of cutting segments are attached to the second end section. The cutting segments are circumferentially spaced apart on the second end section to thereby define gap regions on the second end section between the cutting segments. The hollow body includes a ring groove shaped to receive the at least one weld ring.

According to certain aspects of the invention of this application, the plurality of cutting segments are laser welded to the second end section in the circumferentially spaced alignment about the second end. Then, the at least one weld ring is laser welded into the ring groove. By first laser welding the plurality of cutting segments to the second end section and then welding the at least one weld ring into the ring groove, the welded connection between the plurality of cutting segments and the second end section has much deeper penetration wherein substantially all of the bases of the segments are in welded engagement with the second end of the bit body.

In another embodiment, a mining drill bit is provided comprising a hollow cylindrical body, a plurality of cutting segments, and two weld rings. The hollow cylindrical body has a first end section and an opposite second end section. The plurality of cutting segments are attached to the second end section. The cutting segments are circumferentially spaced apart on the second end section to thereby define gap regions on the second end section between the cutting segments. The hollow body includes a ring groove shaped to receive the two weld rings.

According to certain aspects of the invention of this application, the plurality of cutting segments are laser welded to the second end section in the circumferentially spaced alignment about the second end. Then, the first weld ring is laser welded into the ring groove. Subsequently, the second weld ring is laser welded into the ring groove. By first laser welding the plurality of cutting segments to the second end section and then welding the first and then the second weld ring into the ring groove, the welded connection between the plurality of cutting segments and the second end section has a significantly deeper penetration wherein substantially all of the bases of the segment are in welded engagement with the second end of the bit body.

By having a significantly deeper weld penetration between the segments and the body, the welded joint has been found to be substantially stronger. This strength increase in the welded joint has been found to be substantial enough that the parts fail before the welded joint fails during failure testing.

In other embodiments, the weld rings can be formed from two or more ring segments to allow the weld ring to be accurately positioned within the ring groove after the plurality of cutting segments are laser welded to the second end section in the circumferentially spaced alignment about the second end.

According to certain aspects of the invention of this application, the weld rings are formed by two equal half segments to allow positioning within the ring groove after the cutting segments are welded to the second end.

In yet other embodiments, after the weld segments are welded to the second end and/or after the first weld ring is laser welded into the ring groove, the exposed portions of the ring groove are cleaned or deburred to improve the fit between the weld rings and the ring groove. After the cleaning step, the weld rings are laser welded into the ring groove.

According to certain aspects of the invention of this application, the first weld ring segments are misaligned relative to the second weld ring segments such that the connection points of the first weld ring segments is circumferentially spaced from the connection points of the second weld ring segments.

According to yet other aspects of the invention of this application, the ring groove includes a radially extending edge and an axially extending edge. The radially extending edge having a radial extent and the axially extending edge having an axial extent. The radially extending edge and the axially extending edge meeting at a ring groove vertex.

In another embodiment, provided is a method of producing a mining drill bit according to the following steps:

Providing a drill body having a hollow cylindrical body with a first end section and an opposite second end section.

Providing a ring groove on the second end of the drill body wherein the ring groove is on a radial outer side of the second end;

Providing a plurality of cutting segments wherein the cutting segments can be at least partially diamond coated;

Positioning the plurality of cutting segments about the second end such that a base of each cutting segment of the plurality of cutting segments is in engagement with the second end and extends over the ring groove;

Laser welding the plurality of cutting segments about the second end;

Providing a weld ring having at least two segments;

Positioning the weld ring into the ring groove after the laser welding of the plurality of cutting segments about the second end; and,

Laser welding the weld ring into the ring groove;

According to certain aspects of the invention of this application, the method further includes a cleaning or deburring step between the laser welding of the cutting segments step and the laser welding of the weld ring step.

According to yet other aspects of the invention of this application, the ring groove includes a radially extending edge and an axially extending edge. The radially extending edge having a radial extent and the axially extending edge having an axial extent. The radially extending edge and the axially extending edge meeting at a ring groove vertex wherein the laser welding the plurality of cutting segments about the second end includes a laser weld along the axial extent of the ring groove.

In yet another embodiments and aspects, the laser welding of the weld ring into the ring groove includes a first weld between the plurality of cutting segments and a first side of the weld ring and a second weld between the radially extending edge and a second side of the weld ring.

In yet even another embodiment, the drill bit includes an inner weld ring and an outer weld ring that is adjacent the inner weld ring. The method including a first laser welding step producing a first weld between the plurality of cutting segments and a first side of the inner weld ring, a second laser welding step producing a second weld between the radially extending edge of the ring groove and a second side of the inner weld ring, a third laser welding step producing a third weld between the plurality of cutting segments and a first side of the outer weld ring, a fourth laser welding step producing a fourth weld between the radially extending edge of the ring groove and a second side of the outer weld ring.

According to certain aspects of the invention of this application, the method further includes at least one cleaning or deburring step before at least one of the first and the third welding steps for the weld rings.

According to yet further aspects of the invention of this application, the method further includes at least one cleaning or deburring step after the fourth welding step for the weld rings.

According to even yet other aspects of the invention of this application, the fourth welding step for the outer ring extends inwardly from the radial extent of the radial edge of the ring groove

As will be realized, the subject matter described herein is capable of other and different embodiments and its several details are capable of modifications in various respects, all without departing from the claimed subject matter. Accordingly, the drawings and description are to be regarded as illustrative and not restrictive. Moreover, the dimensions of the drawings are not intended to be limiting wherein these dimensions are in accordance to a single example and should not be interpreted to limit even that example.

### BRIEF DESCRIPTION OF THE DRAWINGS

The foregoing aspects, embodiments and others will be pointed out more fully hereinafter in conjunction with the written description of the various embodiments of the invention illustrated in the accompanying drawings in which:

FIG. 1 is a side-perspective view of a second end of a diamond mining core bit or hole saw according to certain aspects of the invention of this application;

FIG. 2 is an end-perspective view of the second end of the diamond mining core bit or hole saw shown in FIG. 1;

FIG. 3A is a centered-sectional view of a hollow cylindrical body that includes a ring groove according to certain aspects of the invention of this application;

FIG. 3B is a centered-sectional view of the diamond mining core bit or hole saw shown in FIG. 1;

FIG. 4 is a perspective view of an inner weld ring;

FIG. 5 is a perspective view of an outer weld ring;

FIG. 6 is a side perspective view of the mining core bit or hole saw shown in FIG. 1 after the cutting segments are welded to the second end of the hollow cylindrical body;

FIG. 7 is a side perspective view of the mining core bit or hole saw shown in FIG. 1 after the cutting segments are welded to the second end of the hollow cylindrical body and the inner weld ring(s) is welded into the ring groove;

FIG. 8 is a side perspective view of the mining core bit or hole saw shown in FIG. 1 after the cutting segments are welded to the second end of the hollow cylindrical body, the inner weld ring(s) is welded into the ring groove and the outer weld ring(s) is welded into the ring groove;

FIG. 9A is an enlarged sectional view of a portion of the drill body shown in FIG. 6 showing a cutting segment welded to the second end of the hollow cylindrical body;

FIG. 9B is an enlarged sectional view of the portion of the drill body shown in FIG. 7 showing the cutting segment and the inner weld ring welded to the second end of the hollow cylindrical body.

FIG. 9C is an enlarged sectional view of a portion of the drill body shown in FIG. 8 showing the cutting segment, the inner weld ring and the outer weld ring welded to the second end of the hollow cylindrical body.

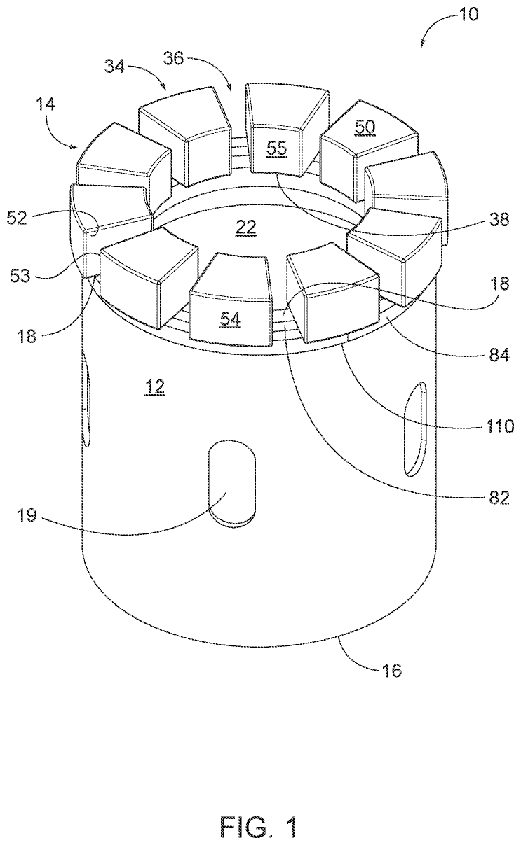

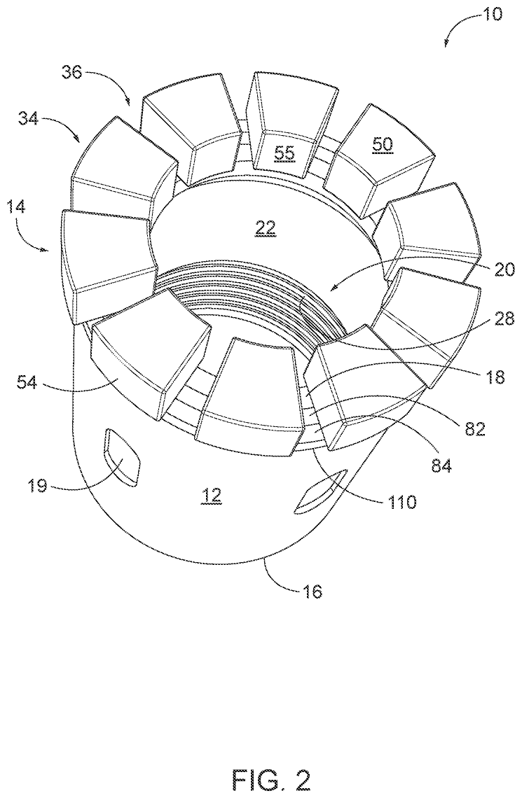

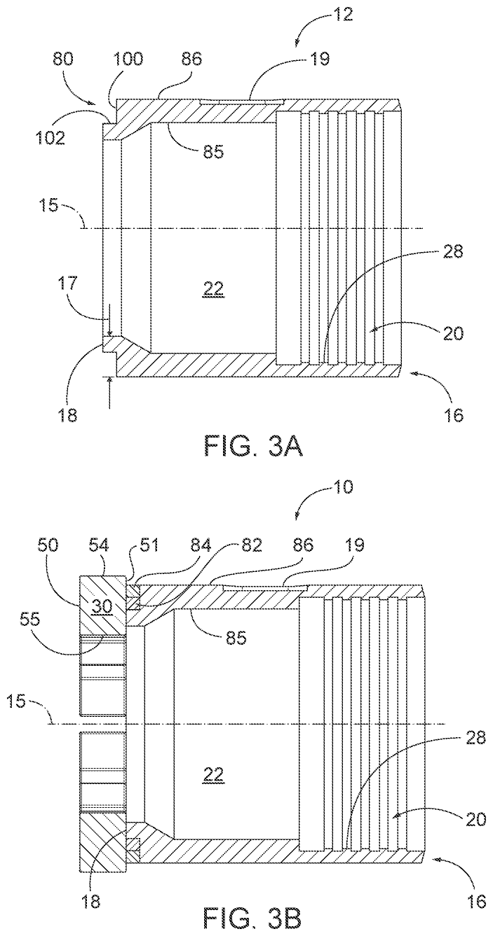

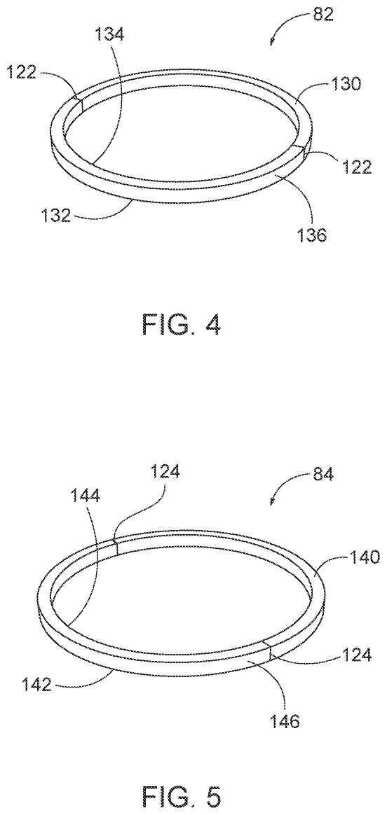

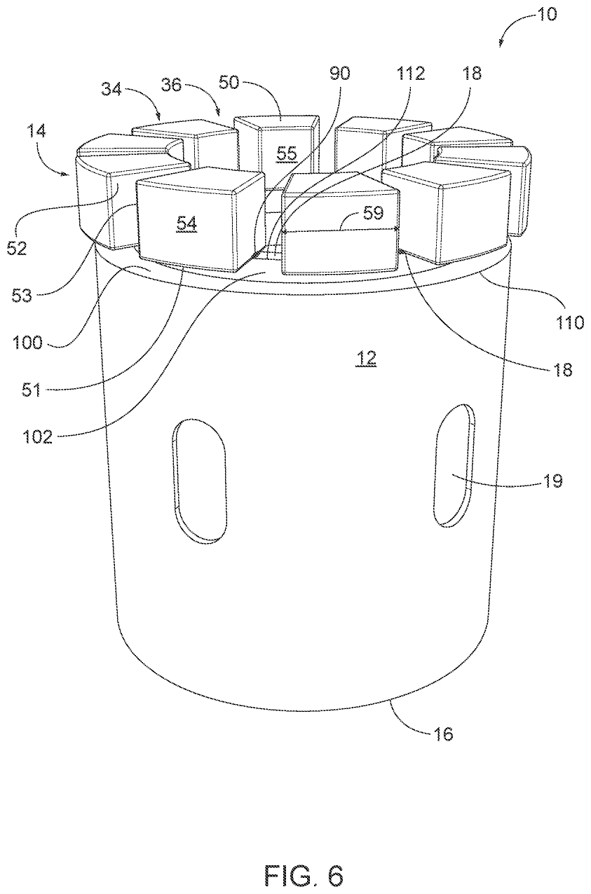

### DETAILED DESCRIPTION OF THE INVENTION

The present invention provides a new and improved mining core bit, and it relates to the bits shown in U.S. Pat. Nos. 8,210,287, 9,701,042 and 9,689,210 which are again incorporated by reference herein in their entireties.

Referring now to the drawings wherein the showings are for purposes of illustrating non-limiting examples of exemplary embodiments of the invention only and not for purposes of limiting same, the figures show several views of the drill bit body. As noted above, any dimensions shown in certain figures are not to limit the invention of this application in that they are merely directed to one particular example of the invention. Shown is a diamond mining core drill bit tool 10 of the present invention that comprises a hollow cylindrical body 12 having a first end section 16 and opposite second end section 18. The first end 16 is adapted to connect to a reamer or drill pipe for rotating the tool in relation to an associated material to be drilled (not shown). The body of the drill and the reamer are commonly formed of steel as is conventional in the mining drill industry. The second end section 18 has a cutting head 14 mounted thereto. The cutting head 14 comprises a plurality of cutting segments 30, each cutting segment 30 having a connecting portion 38 that is welded to second end section 18.

In greater detail, drill bit 10 includes elongate hollow cylindrical body 12 and cutting head 14 disposed on body 12. The body 12 has first end section 16 and opposite second end section 18. The body extending about a body axis 15 and has a length in the axial direction defined by the distance from the distal end of the first end section 16 to the distal end of the second end section 18. The hollow body 12 has a thickness 17 defined by the distance between the opposite sides of the hollow body, i.e. the difference between the inside and the outside radius of the cylindrical body. Thickness 17 of the body 12 may vary without detracting from the invention of this application. Body 12 can further include reamer openings 19 for reamers (not shown).

The first end section 16 has an attaching portion 20 for selectively attaching the core drill bit 10 to an associated driver such as, for example, a reamer or drill pipe for rotating the core drill bit 10 relative to the associated material. The second end section 18 is joined with the plurality of cutting segments 30 and optionally joined with a plurality of reinforcing members (not shown) to define a cutting head 14. The second end section 18 is defined by a portion of the body 12 that is joined to connecting portion 38 of the cutting segments 30 along with portions of the body 12 located therebetween. The cutting head 14 is formed on the second end section 18.

Further, the cylindrical body 12 defines a circular hole or opening 22 coaxial with axis 15 and extending through body 12 so that the drill bit may function as a coring drill bit to remove or extract materials such as, for example, soil samplings, and/or rock or other formations. Also, the opening 22 at the first end section 16 enables access to the attaching portion 20. In one embodiment, the attaching portion 20 comprises an internal threaded portion 28. The internal threaded portion 28 enables the selective connection of the subject drill bit 10 with an associated reamer, drill pipe, or driving member (not shown), having corresponding external threaded portions.

As is shown, each of the plurality of cutting segments 30 is circumferentially spaced apart evenly on the second end section 18 to define alternating cutting segment regions 34 and gap regions 36 of the cutting head 14 about axis 15. It will be appreciated that it is not necessary for the cutting segments 30 to be evenly spaced apart, but only that the cutting segments 30 have space between them on the second end section 18 to define gap regions 36 on the cutting head 14.

The cutting head 14 of the subject drill bit 10 comprises a plurality of separate and distinct cutting segments 30 mounted to the second end section 18 of the body 12 such that the cutting head and the body form a unitary piece. The cutting segments 30 each have a top face 50, a bottom face 51 comprising the connecting portion 38, a leading face 52, a trailing face 53, an outer face 54, and an inner face 55.

The cutting segments 30 have a height 57, a width 58 between outer face 54 and inner face 55, and a length 59. When referring to the height of the cutting segments, this can be the average of the largest and smallest measurements between the top face 50 and the bottom face 51. When referring to the width of the cutting segments, this can be the average of the largest and smallest measurements between the outer face 54 and the inner face 55. When referring to the length of the cutting segments, this can be the average of the largest and smallest measurements between the leading face 52 and the trailing face 53. It will be understood that respectively opposite faces of the cutting segments, i.e. top and bottom, outer and inner, and leading and trailing, can be but are not necessarily parallel to each other, and the cutting segments can be irregularly shaped in accordance with the present subject matter, such as wedge or pie shaped. The shape and dimensions of the segment are generally configured to meet the desired drilling application.

As with conventional bits, the cutting segments 30 are slightly wider than thickness 17 of the hollow cylindrical body 12 at the second end section 18 as shown in the figures, so as to provide sufficient clearance for the body during mining, drilling, or cutting operations.

In one set of embodiments, the cutting segments are attached to the second end section 18 so that each cutting segment simultaneously extends both radially in towards the opening 22 and radially out away from the opening; both extending over thickness 17 of the body at the second end section. That is, width 58 of the cutting segments is greater than thickness 17 of body 12 such that when the segments are attached to end section 18, outside face 54 and inside face 55 of the cutting segments extend past and hang over both sides of the body 12 at the second end section 18 to create a kerf wider than the drill bit body. This can be seen in the Figures.

In one set of embodiments, the cutting segments 30 are circumferentially spaced apart substantially evenly on the second end section 18 to define gap regions 36 and are coaxial with axis 15. The distance between adjacent cutting segments, which defines each gap region, can be the average of measurements between one cutting segment and an adjacent cutting segment. As shown in the Figures, a total of ten (10) cutting segments 30 can be provided. However, more or less segments may be used as necessary or desired without detracting from the invention of this application.

Cutting segments 30 can comprise almost any metal including a mixture of metals such as, for example, one or more of molybdenum, silver, iron, copper, cobalt, and alloys of such metals, and metal carbides, and mixtures thereof, along with diamonds. In one aspect, the cutting segments 30 further include diamond particles/grit/powder dispersed therein, which can be at about 0.01-90% by weight of the cutting segments. In one particular aspect, the cutting segments comprises at least about 2% diamond particles by weight. In another particular aspect, the cutting segments comprise from 3% to about 80% by weight of diamond particles. The concentration and arrangement of diamond particles as well—as the relative amounts of other components, for example the percentage of each metal in the mixture—can be varied between different portions of the cutting segments. Other compositions may be utilized as well.

In one set of embodiments, top face 50 of cutting segments 30 have a shape other than a flat shape that is perpendicular to the drill bit body 12. The top face 50 comes into contact with the associated material during drilling operations and can be in the form of a flat face, a sloped face, a curved face, a stepped face, a jagged face, have a depression therein, and/or combinations thereof. It is contemplated that top face 50 can have various other forms not limited by the examples provided herein. The cutting segments 30 can also have one or more inserts (not shown). The insert can be positioned anywhere within the cutting segment 30. The inserts can be cold pressed and fired and/or sintered to form the cutting segment 30 and comprises a metal such as, for example molybdenum, tungsten, silver nickel, iron, copper, cobalt or mixtures and alloys thereof including carbides of various metals. The cutting head 14 can further include at least one reinforcing member (not shown) disposed in each of the gap regions between adjacent cutting segments 30. The reinforcing members can be separate and distinct from the body and from the cutting segments and bonded to the second end section 18, to the cutting segments 30, or to both. However, it has been found that these reinforcing members are not necessary in view of the improved strength characteristics of the new drill bit according to the invention of this application.

As will be discussed in greater detail below, laser welding can be used to secure the cutting segments to the drill body. The laser can be directed toward the interface between the cutting segments 30 and the second end section 18 from the direction of the outer face 54 of the cutting segments 18. Specifically, the laser can be from the outer face 54 of the cutting segments 30 in the area where the bottom face 51 (connecting portion 38) of the cutting segment contacts the body 12. The laser penetration depth relative to the thickness of the body 12 is improved in accordance with the present invention, which will be discussed more below, wherein only an outer laser weld provides the needed weld penetration. The depth of the penetration at the second end section 18 is measured from the outside radius of the cylindrical body to the inside radius of the body. It will be appreciated that, the laser could be directed from the direction of the inner face 51 of the cutting segments, or even along one or more of the leading 52 or trailering faces 53 of the cutting segments without detracting from the invention of this application. However, it has been found that it is difficult to direct the laser toward the inner face 51 of the cutting segments, the leading 52 and trailering faces 53 of the cutting segments. Moreover, it has been found that according to the present invention the penetration depth of the laser weld when the laser is directed toward the interface between the cutting segments 30 and the second end section 18 from the direction of the outer face 54 of the cutting segments 18 is so significant that it is not necessary to perform the difficult and costly laser welds on the inner face 51 of the cutting segments, the leading 52 and trailering faces 53 of the cutting segments. Moreover, it is not necessary to utilize capacitive discharge welding, reinforcing members and/or complexly shaped cutting segments with the invention of this application, which will be discussed more below.

The present invention provides a new and improved diamond mining core drill bit or hole saw for cutting annular holes in rock, earth, and similar materials and, further, includes methods of manufacturing these mining core drill bits. More particularly, the present invention provides a drill bit having cutting segments that are more securely attached to the drill bit body. It has been found that the diamond mining core drill bit according to the present invention is much more durable than even the best prior art mining core drill bits. Even more particularly, the diamond mining core drill bit includes a welded bond between the cutting segments and the drill bit body that is substantially stronger than prior art drill bits.

In greater detail, mining drill bit 10 includes a hollow cylindrical body 12 that has a ring groove 80 and at least one weld ring 82. The plurality of cutting segments 30 are attached to the second end section and are circumferentially spaced apart on the second end section and about axis 15 to thereby define gap regions 36 on the second end section between the cutting segments. The ring groove is shaped to receive the at least one weld ring as will be discussed more below.

According to the invention of this application, the plurality of cutting segments can be attached to the second end by laser welding without the need for capacitive discharge welding. The penetration depth of the laser welding is drastically improved by utilizing the ring groove and one or more weld rings wherein weld depth approaches or achieves 100 percent penetration depth that was not before possible. As can be appreciated, by achieving near 100 percent penetration depth, the connection strength between the cutting segments and the drill body is significantly improved.

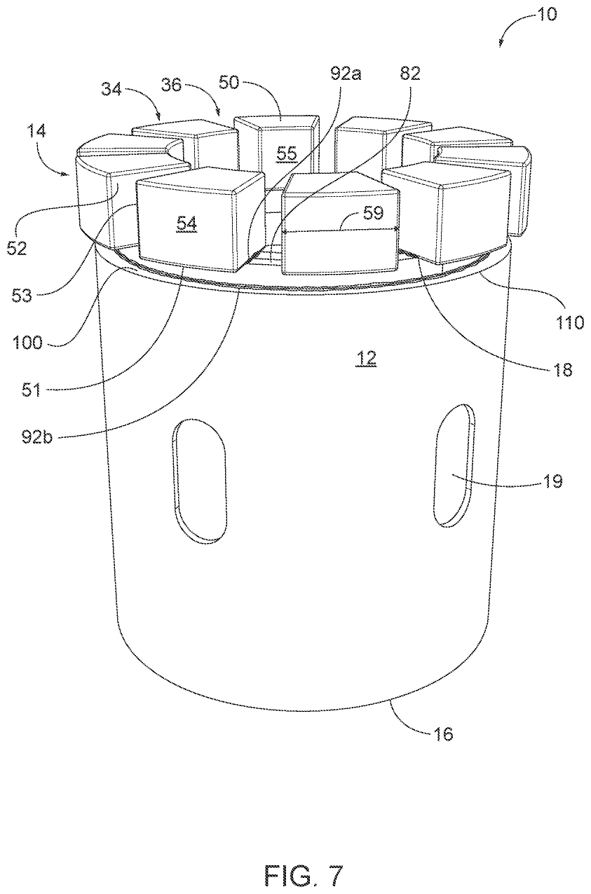

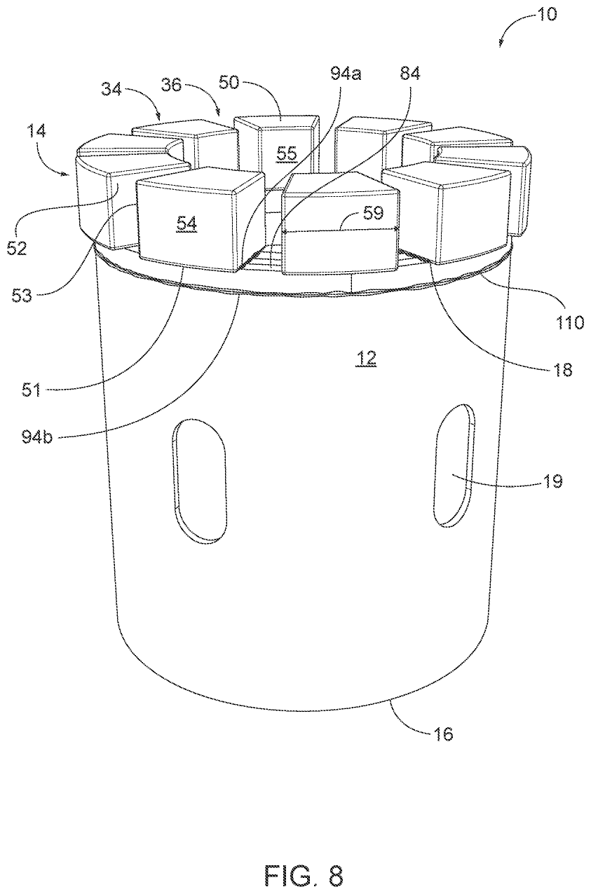

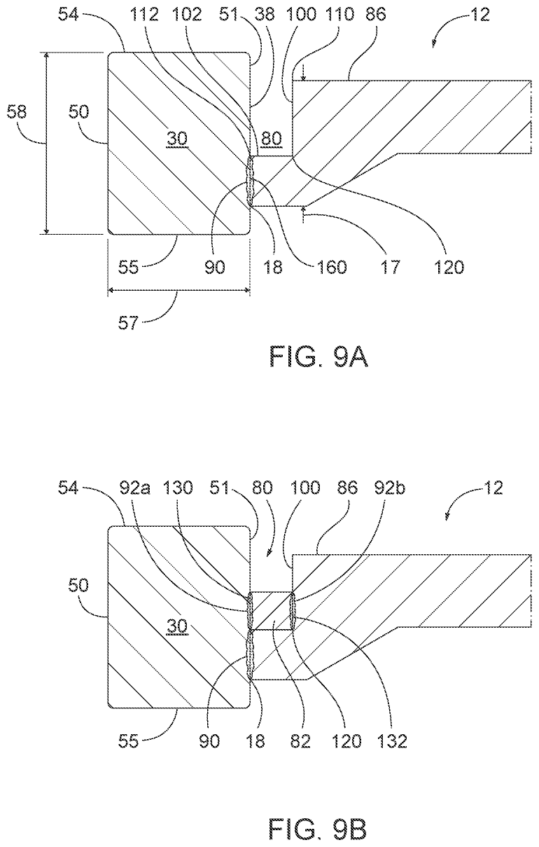

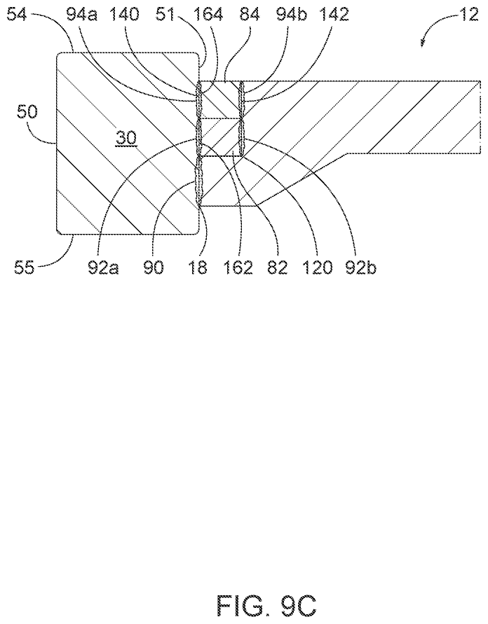

With special reference to FIG. 6, cutting segment 30 of the plurality of cutting segments are first laser welded to second end 18 by laser welding without the need for capacitive discharge welding. This forms a first weld bead 90, which will also be discussed in greater detail below. With reference to FIG. 7, the at least one weld ring 82 is then laser welded into the ring groove, which forms at least one second weld bead 92. In greater detail, ring groove 80 can be an annular groove extending about axis 15 having a radially extending edge 100 transverse to axis 15 and an axially extending edge 102 coaxial to axis 15. The radially extending edge having a radial extent 110 and the axially extending edge having an axial extent 112. The radially extending edge and the axially extending edge meeting at a ring groove vertex 120. The at least one second weld bead 92 can include second segment weld bead 92a between segments 30 and weld ring 82 and second groove weld bead 92b between radially extending edge 100 of ring groove 80 and weld ring 82.

By first laser welding the plurality of cutting segments to the second end section and then welding the at least one weld ring into the ring groove, the welded connection between the plurality of cutting segments and the second end section has much deeper penetration wherein the overall weld bead is a combination of weld beads 90 and 92. Thus, substantially all of the bases of the cutting segments are in welded engagement with the second end of the bit body.

According to another embodiment, weld ring 82 can be an inner weld ring and the mining drill bit can further include an outer weld ring 84. While more than two weld rings could be used without detracting from the invention of this application, the example shown has two weld rings and it has been found that two weld rings perform exceptionally well for the primary size ranges of these tools. As will be discussed more below, the inner and/or outer weld rings can be form by one or more ring segments.

The plurality of cutting segments are laser welded to the second end section in the circumferentially spaced alignment about the second end forming first weld bead 90. Inner weld ring 82 is then laser welded into the ring groove forming one or more second weld beads 92. Outer weld ring 84 is then laser welded into the ring groove forming one or more third weld beads 94. By first laser welding the plurality of cutting segments to the second end section and then welding the inner and/or then the outer weld ring into the ring groove, weld beads 90, 92 and 94 form the overall weld bead between the plurality of cutting segments and the second end section, which produces significantly deeper weld penetration wherein substantially all of the bases of the cutting segments are in welded engagement with the second end of the bit body by laser welding alone and by laser welding directed from only the outside edge of the tool. This was before not possible even with capacitive discharge welding used in combination with laser welding. Moreover, it has been found that the bond strength of the overall weld bead between the cutting segments and the bit body is substantially improved. This strength increase in the welded joint has been found to be substantial enough that the parts fail before the welded joint fails during failure testing.

In order to allow the inner and/or outer weld rings to be positioned after the cutting segments are welding to the second end, the weld rings can be formed from two or more ring segments. In one set of embodiments, the weld rings can be formed by two equal half ring segments.

In order to improve the fit between the inner and/or outer weld rings and the ring groove, the ring groove can be cleaned or deburred before the weld rings are positioned in the ring groove. This can be after the laser welding of the cutting segments and/or after the welding of the inner weld ring. This can be used to improve the fit between the weld rings and the ring groove. After the cleaning step, the inner and/or outer weld ring is positioned in the ring groove and then laser welded into the ring groove.

According to yet other embodiments, inner weld ring segments of inner ring 82 has connection points 122 and outer ring segments of outer ring 84 has connection points 124 and these connection points can be misaligned relative to one another such that the connection points 122 of the inner weld ring segments are circumferentially spaced from the connection points 124 of the outer weld ring segments.

Again, ring groove 80 can include radially extending edge 100 and axially extending edge 102. The radially extending edge 100 having radial extent 110 and the axially extending edge having axial extent 112. The radially extending edge and an axially extending edge meeting at ring groove vertex 120 wherein the weld rings can extend between radially extending edge 100 and segment bottom face 51 and outer ring 84 can extend about inner ring 82.

In another embodiment, provided is a method of producing a mining drill bit according to the following steps:

Providing drill body 12 having a hollow cylindrical body with first end section 16 and opposite second end section 18. The drill body further including a radial inner side 85 forming and/or defining opening 22 and a radial outer side 86 with a ring groove 80 on second end 18 wherein the ring groove extends inwardly from radial outer side 86 of the second end;

Providing cutting segments 30 wherein the cutting segments can be at least partially diamond coated;

Positioning the plurality of cutting segments about the second end such that base 51 of each cutting segment of the plurality of cutting segments is in engagement with second end 18 and extends over ring groove 80;

Laser welding the plurality of cutting segments directly to body 12 about the second end forming first laser bead 90;

Providing weld ring 82 having at least two segments;

Positioning weld ring 82 into ring groove 80 after laser welding the plurality of cutting segments to body 12 about the second end;

Laser welding the weld ring into the ring groove forming segment and/or groove weld beads 92a and/or 92b, respectively;

According to certain aspects of the invention of this application, the method further includes a cleaning or deburring step between the laser welding of the cutting segments step to the body and the laser welding of the weld ring step.

According to yet other aspects of the invention of this application, the ring groove includes radially extending edge 100 and axially extending edge 102. The radially extending edge having radial extent 110 and the axially extending edge having axial extent 112. The radially extending edge and an axially extending edge meeting at ring groove vertex 120. Moreover, inner ring includes a first side edge 130, a second side edge 132, an inner edge 134 and an outer edge 136. Weld bead 90 extending radially inwardly from axial extent 112 of ring groove 80 and along side 18 of body 12. When in an operable position, inner edge 134 is adjacent to or engages axially extending edge 102, first side edge 130 is adjacent to or engages cutting segment surfaces 51, second side edge 132 is adjacent to or engages radially extending edge 100.

The laser welding of weld ring 82 into the ring groove includes segment weld bead 92a between cutting segment surfaces 51 of cutting segments 30 and first side edge 130 of weld ring 82 and a groove weld bead 92b between radially extending edge 100 and second side edge 132.

In yet other embodiments, drill bit 10 includes both inner weld ring 82 and outer weld ring 84 that is adjacent inner weld ring 82 and radially outwardly of inner ring 82. The method further including a laser welding step producing a segment weld bead 94a between cutting segment surface 51 and a first side edge 140 of outer ring 84 and second groove weld bead 94b between a second side edge 142 of outer ring 84 and radially extending edge 100 of ring groove 80. When in an operable position, inner edge 144 of outer ring 84 is adjacent to or engages outer edge 136 of inner ring 82, first side edge 140 is adjacent to or engages cutting segment surfaces 51, second side edge 142 is adjacent to or engages radially extending edge 100.

According to certain aspects of the invention of this application, the method further includes at least one cleaning or deburring step before at least one of the weld ring welding steps.

According to yet further aspects of the invention of this application, the method further includes at least one cleaning or deburring step after the last welding step for the weld rings.

Accordingly, the drill bit includes two overall weld beads. The first overall weld bead along connecting portion 38 of segments 30 being a combination of weld beads 90, 92a and 94a. The second overall weld bead along groove 80 being a combination of weld beads 92b and 94b. As can be appreciated, the first and second overall weld beads provide substantial weld penetration and weld coverage between the cutting segments and the drill body. Moreover, this is a weld penetration and weld coverage between the cutting segments and the drill body not before possible. Yet even further, this is achieved by laser welding only and by laser welding only about the outside of the drill body.

According to one set of embodiments, diamond mining core drill bit tool 10 includes cylindrical body 12 having first end section 16 and opposite second end section 18 with opening 22 therethrough that can be coaxial with axis 15. Cylindrical body 12 further including radial inner side 85 forming and/or defining opening 22 and radial outer side 86 with ring groove 80 on second end 18 extending inwardly from radial outer side 86 of the second end wherein radial inner side 85 and radial outer side 86 define thickness 17 that can vary between end sections 16 and 18.

Diamond mining core drill bit tool 10 further includes plurality of cutting segments 30 that are circumferentially spaced about second end section 18 of body 12. Each cutting segment 30 of the plurality of cutting segments has top face 50 and bottom face 51 wherein the bottom face includes connecting portion 38. Each cutting segment can further include outer face 54 and inner face 55. Outer face 54 and inner face 55 define segment width 58 that can be greater than thickness 17 such that outer face 54 and inner face 55 extend past body 12.

Tool 10 having first weld bead 90 between a first portion 160 of connecting portion 38 and second end 18 of body 12.

Tool 10 further including at least one weld ring 82 and ring groove 80 being shaped to receive the at least one weld ring 82 such that at least one weld ring 82 extends about ring groove 80 and first side edge 130 faces cutting segment bottom face 51 and second side edge 132 faces radially extending edge 100 of ring groove 80. Tool 10 further including at least one second weld bead 92 between a second portion 162 of connecting portion 38 and radially extending edge 100.

According to certain aspects of the invention, the at least one second weld bead 92 can include second segment weld bead 92a between second portion 162 and first side edge 130 of weld ring 82 and second groove weld bead 92b between radially extending edge 100 of ring groove 80 and second side edge 132 of weld ring 82.

According to another set of embodiments, the at least one weld ring includes at least one inner weld ring 82 and tool 10 further includes at least one outer weld ring 84 wherein the at least one outer ring is shaped and sized to extend about at least one inner ring 82 and at least partially within ring groove 80. Tool 10 further includes at least one third weld bead 94 between a third portion 164 of connecting portion 38 and radially extending edge 100.

According to certain aspects of the invention, the at least one third weld bead 94 can include third segment weld bead 94a between third portion 164 and first side edge 140 of second weld ring 84 and third groove weld bead 94b between radially extending edge 100 of ring groove 80 and second side edge 142 of second weld ring 84.

According to this set of embodiments, drill bit 10 includes two overall weld beads. The first overall weld bead is along connecting portion 38 of segments 30 and being a combination of weld segment beads 90, 92a and 94a. The second overall weld bead being along surface 100 of groove 80 and being a combination of groove weld beads 92b and 94b. Thus, weld depth approaches or achieves 100 percent penetration depth that was not before possible.

As will be realized, the subject matter described herein is capable of other and different embodiments and its several details are capable of modifications in various respects, all without departing from the claimed subject matter. Accordingly, the drawings and description are to be regarded as illustrative and not restrictive. Moreover, the dimensions of the drawings are not intended to be limiting wherein these dimensions are in accordance to a single example and should not be interpreted to limit even that example. Yet further, the drill bit of this application can include any other features known in the art include reamer attached, modifications of the diamond concentrations and can further include one or more reamer features on the drill bit itself as is shown in some of the drawings.

In addition, while considerable emphasis has been placed on the preferred embodiments of the invention illustrated and described herein, it will be appreciated that other embodiments, and equivalences thereof, can be made and that many changes can be made in the preferred embodiments without departing from the principles of the invention. Furthermore, the embodiments described above can be combined to form yet other embodiments of the invention of this application. Accordingly, it is to be distinctly understood that the foregoing descriptive matter is to be interpreted merely as illustrative of the invention and not as a limitation.

It is claimed:

1. A diamond mining core drill bit tool comprising a cylindrical body having a first end section and an opposite second end section with an inner axial opening therethrough, the cylindrical body further including a radial inner side forming and/or defining the inner axial opening extending along a body axis and a radial outer side, the cylindrical body having a ring groove extending about the second end, the radial inner side and the radial outer side defining a body thickness at the second end section; the tool further comprising a plurality of cutting segments that are circumferentially spaced about the second end section of the cylindrical body wherein each cutting segment of the plurality of cutting segments has a top face and a bottom face wherein the bottom face includes a connecting portion; the tool having a first weld bead between a first portion of the connecting portion and the second end of the cylindrical body; the tool further comprising at least one weld ring wherein the ring groove includes a radially extending edge and is shaped to receive the at least one weld ring such that the at least one weld ring extends about the ring grove; the at least one weld ring having a ring first side edge that faces the cutting segment bottom face and a ring second side edge that faces the radially extending edge of the ring groove; the tool further including at least one second weld bead between a second portion of the connecting portion and the radially extending edge of the ring groove.

2. The diamond mining core drill bit tool of claim 1, wherein the at least one second weld bead includes a second segment weld bead between the second portion and the first side edge of the weld ring and a second groove weld bead between the radially extending edge of the ring groove and the second side edge of the weld ring.

3. The diamond mining core drill bit tool of claim 1, wherein the ring groove is an annual ring groove extending inwardly from the radial outer side and is coaxial with the body axis, the ring groove having an axially extending edge that is perpendicular to the radially extending edge and wherein the weld ring extends about the axial extending edge and engages the radially extending edge.

4. The diamond mining core drill bit tool of claim 3, wherein the axially extending edge has an axial extent, the first weld bead extending radially inwardly from the axially extending edge along the first portion of the connecting portion and the second end of the cylindrical body.

5. The diamond mining core drill bit tool of claim 4, wherein the radially extending edge and the axially extending edge meet at a ring groove vertex, the at least one second weld bead includes a second segment weld bead between the second portion and the first side edge of the weld ring that extends radially outwardly from the axial extent and a second groove weld bead between the radially extending edge of the ring groove and the second side edge of the weld ring extends radially outwardly from the ring groove vertex.

6. The diamond mining core drill bit tool of claim 1, wherein the at least one weld ring extends about the entire ring grove and fully fills the ring groove.

7. The diamond mining core drill bit tool of claim 1, wherein the at least one weld ring is formed by two ring segments

8. The diamond mining core drill bit tool of claim 1, wherein the at least one weld ring is an inner weld ring and the tool further including an outer weld ring wherein the outer weld ring is shaped and sized to extend about the inner weld ring, the tool further including at least one third weld bead between a third portion of connecting portion and the radially extending edge.

9. The diamond mining core drill bit tool of claim 6, wherein the at least one third weld bead includes a third segment weld bead between the third portion of the segment and a first side edge of the outer weld ring and a third groove weld bead between the radially extending edge of the ring groove and a second side edge of the outer weld ring.

10. The diamond mining core drill bit tool of claim 9, wherein the drill bit includes a first overall weld bead and a second overall weld bead; the first overall weld bead includes the first weld bead, the second segment weld bead and the third segment weld bead; the second overall weld bead includes the second groove weld bead and the third groove weld bead.

11. The diamond mining core drill bit tool of claim 9, wherein the inner weld ring is formed by two inner ring segments and the outer weld ring is formed by two outer ring segments.

12. The diamond mining core drill bit tool of claim 11, wherein the two inner ring segments and the two outer ring segments are misaligned relative to one another.

13. A method of producing a mining drill bit including the steps of:
providing a drill body having a hollow cylindrical body with a first end section and an opposite second end section; the drill body further including a ring groove extending about the second end second and extending inwardly from a radial outer side of the second end;
providing a plurality of cutting segments;
positioning the plurality of cutting segments about the second end such that a base of each cutting segment of the plurality of cutting segments is in engagement with the second end;
laser welding said each of the plurality of cutting segments directly to the cylindrical body about the second end forming a first laser bead;
providing a weld ring;
positioning the weld ring into ring groove after laser welding the plurality of cutting segments to the cylindrical body;
laser welding the weld ring into the ring groove;

14. The method according to claim 13, wherein the laser welding step welding the weld ring to the groove forms a segment weld bead between the plurality of segments and the weld ring and a groove weld bead between the weld ring and the second end section of the cylindrical body.

15. The method according to claim 13, further including a cleaning and/or deburring step after the first laser welding step.

16. The method according to claim 13, wherein the weld ring is an inner weld ring and the method further including the sept of providing an outer weld ring and welding the outer weld ring within the ring groove after the step of welding the inner weld ring to the ring groove.

17. The method according to claim 16, wherein outer weld ring is formed from outer ring segments having outer ring connection points between the outer ring segments and the inner weld ring is formed from inner ring segments having inner ring connection points between the inner ring segments; the method further including the step of misaligning the outer ring connection points from the inner ring connection points.
